(19) United States
(12) Patent Application Publication
(10) Pub. No.: US 2008/0200997 A1
(43) Pub. Date: Aug. 21, 2008

(54) Broadcast control of cellular stochastic control systems with applications to actuators

(76) Inventors: Haruhiko Harry Asada, Lincoln, MA (US); Jun Ueda, Cambridge, MA (US); Lael U Odhner, Somerville, MA (US)

Correspondence Address: MILLS & ONELLO LLP, ELEVEN BEACON STREET, SUITE 605, BOSTON, MA, 02108, US

(21) Appl. No.: 11/708,403

(22) Filed: Feb. 20, 2007

(51) Int. Cl. G05B 11/01; G05B 15/02

(52) U.S. Cl. 700/12; 700/9

(57) ABSTRACT

A broadcast feedback method is presented for distributed stochastic control of an actuator system consisting of many cellular units. The method can be implemented for an artificial cellular actuator, consisting of many units of smart actuator material with a random signal generator. The output of the actuator system is an aggregate effect of numerous cellular units, each taking a bi-stable ON-OFF state. A central controller broadcasts the error between the aggregate output and a reference input. The central controller broadcasts the overall error signal to all the cellular units uniformly. In turn, each cellular unit makes a stochastic decision with a state transition probability modulated in relation to the broadcasted error. Even in the absence of deterministic coordination, the ensemble of the cellular units can track a given trajectory stably.

### BACKGROUND OF THE INVENTION

There is a need for controlling an artificial muscle actuator comprising many small units of smart material. The conventional art in this field includes actuators using shape memory alloys (SMA), conducting polymers, elastomers, and piezoelectric transducers. Although the energy density of these smart materials is significantly higher than that of skeletal muscles and traditional electromechanical actuators, the performance of these materials still falls short of the traditional counterparts. These actuators perform poorly on the macroscopic scale compared to the meso- and micro-scales. The strain state of these materials is often difficult to control, due to hysteresis and highly non-linear characteristics.

This problem can be overcome by dividing the actuator material into many small units and by controlling each unit in an ON/OFF manner. The aggregate output, that is, the sum of the individual units, is proportional to the number of the ON units. With this simple ON-OFF control, the actuator control system, although complex in the individual material properties, becomes tractable and predictable, resembling the characteristics of stepping motors. As the actuator material is divided into finer units, however, the control system becomes increasingly complex and costly. When an actuator contains many thousands of small sub-units, as in muscle tissue, it is difficult to implement a centralized controller that gathers the states of all the sub-units, plans the coordination, and sends commands to each individual actuator. This architecture would require incredibly complex wiring and a very powerful processor. Even though the wiring problem can be solved by serial data transmission, a broadband transmission line would be necessary for addressing a vast number of units and transferring data.

The following patents illustrate existing control methods for a system that contains a plurality of modules.

U.S. Pat. No. 4,864,412 discloses maintaining a system compromising multiple control units, in which each local unit accesses a sensed parameter based on time delay as a function to a random value generated in each individual unit. This method is for the investigation of the status of the system, not for coordinating the aggregate behavior of the system.

U.S. Pat. No. 6,574,958 discloses a displacement amplifying binary actuator, compromising several thin plates of shape memory alloys connected in series. Only two discrete displacements can be created by the system of U.S. Pat. No. 6,574,958, which means all plates take the same ON or OFF state.

U.S. Pat. No. 6,377,878 provides a method to control multiple robotic vehicles to converge to a goal by avoiding collisions between vehicles or collisions with other obstacles. U.S. Pat. No. 6,377,878 is based on design and implementation of a fuzzy controller, having predictable convergence characteristics, and generating a plurality of vehicle control commands.

U.S. Pat. No. 5,365,423 provides a method for diagnosing, monitoring and fail safe operation for a system with distributed sensors and actuators, taking binary states. U.S. Pat. No. 4,833,624 concerns operating distributed robots from a central controller that communicating with local computers through a high speed system bus. U.S. Pat. No. 6,575,802 discloses controlling a plurality of robotic modules. Each module contains an actuator, memory, controller, and communication means. Each module has a capability of storing a sequence of behaviors to be executed, enabling flexible design for robotic toys. U.S. Pat. No. 5,365,423, U.S. Pat. No. 4,833,624 and U.S. Pat. No. 6,575,802 require a large bus line for the communication between a centralized controller and local controllers, or among local controllers.

U.S. Pat. No. 3,918,298 discloses a multiple actuator control system for vibration tables. Each actuator adjusts its load in the relation to the average force of the other actuators. This control is performed in a deterministic manner.

U.S. Pat. No. 3,460,096 and U.S. Pat. No. 3,519,998 provide a way to control a multiple actuator system by implementing self-organizing control. U.S. Pat. No. 3,460,096 and U.S. Pat. No. 3,519,998 utilize a statistical decision making theory to improve the performance trend of the system. The self-organizing controller, including a performance assessment and a probability state variable conditioning logic, is used for global decision-making, not used for the local decision making at each unit. In addition, the self-organizing controller is placed outside of the local units, which might require a complex wiring when the number of the controlled units is increased. In addition, this art does not guarantee the convergence of the ensemble behavior.

### SUMMARY OF THE INVENTION

The present invention is directed to a control system that includes a plurality of small cellular units. Each of the plurality of cellular units includes a stochastic state machine that controls the state of the unit modulated by a command broadcasted by a central controller.

In one embodiment, the plurality of cellular units are actuators. In another embodiment, the actuator is made by actuator material with hysteresis, and a bi-stable ON-OFF control is applied to avoid nonlinear transitions. In another embodiment, the plurality of cellular units are connected to each other directly. In another embodiment, the plurality of cellular units are connected to each other directly in series. In another embodiment, the plurality of cellular units are connected to each directly other in parallel. In another embodiment, the plurality of cellular units are connected to each directly in a combination of in series and in parallel. In another embodiment, the plurality of cellular units are connected to each other through mechanical impedance. In another embodiment, the plurality of cellular units are connected to each other through mechanical impedance in series. In another embodiment, the plurality of cellular units are connected to each other through mechanical impedance in parallel. In another embodiment, the plurality of cellular units are connected to each other through mechanical impedance in a combination of in series and in parallel.

In one embodiment, the stochastic state machine has two states and controls the cellular unit in a binary manner. In another embodiment, the actuator is made by actuator material with hysteresis, and a bi-stable ON-OFF control is applied to avoid nonlinear transitions. In another embodiment, the stochastic state machine is comprised of a pulse-width modulator (PWM) which modulates the broadcasted signal, a sampler which samples an output signal of the PWM in sync with a random pulse generator, and a bi-stable ON-OFF controller which controls the plurality of cellular units.

In one embodiment, the central controller broadcasts the signal based on a reference input and an aggregate output of the plurality of cellular units. In another embodiment, the central controller broadcasts an error between the reference input and the aggregate output of the plurality of cellular units. In another embodiment, a transition probability for each cell is proportional to the broadcasted error.

### BRIEF SUMMARY OF THE INVENTION

The foregoing and other objects, features and advantages of the invention will be apparent from the more particular description of a preferred embodiment of the invention, as illustrated in the accompanying drawings in which like reference characters refer to the same parts throughout the different views. The drawings are not necessarily to scale, emphasis instead being placed upon illustrating the principles of the invention.

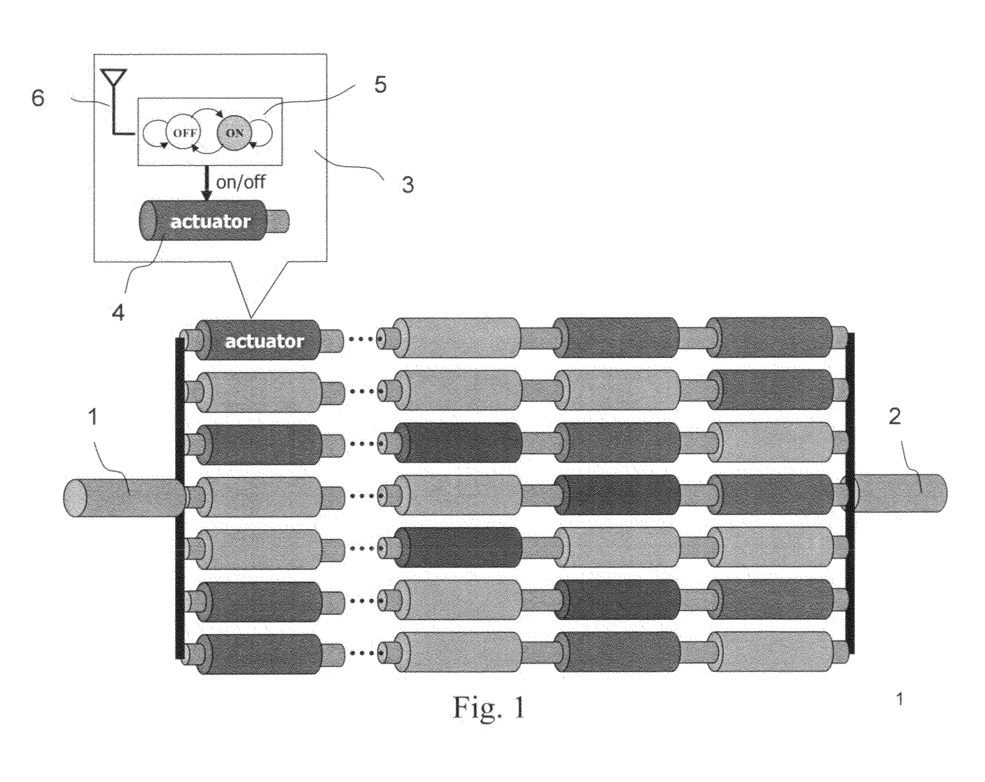

FIG. 1A contains a schematic perspective view of cellular actuators and FIG. 1B contains a detailed perspective view of one of the cellular actuators of FIG. 1A with a stochastic state machine, in accordance with one embodiment of the present invention.

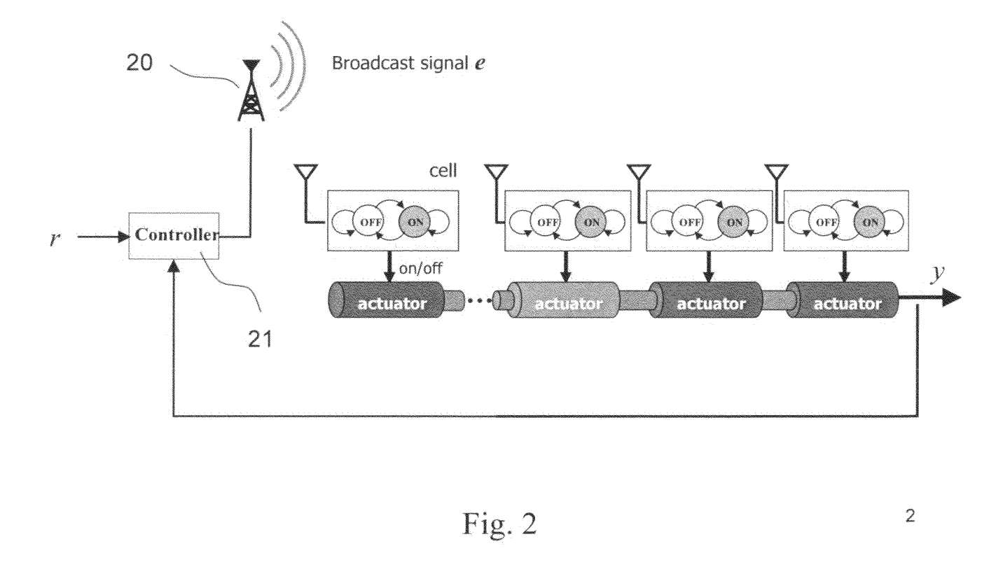

FIG. 2 contains a schematic perspective view of a broadcast control system in accordance with one embodiment of the present invention.

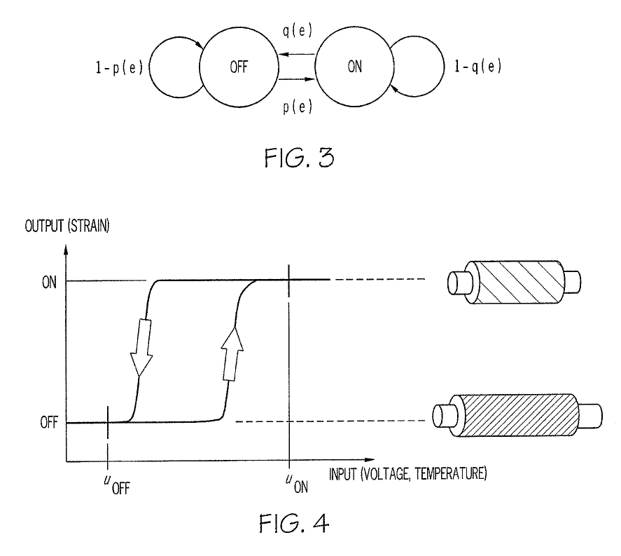

FIG. 3 contains a diagram of a stochastic state machine modulated by a broadcasted signal e in accordance with one embodiment of the present invention.

FIG. 4 contains a hysteresis curve which illustrates the avoidance of hysteresis of a material by a bistable ON-OFF control in accordance with one embodiment of the present invention.

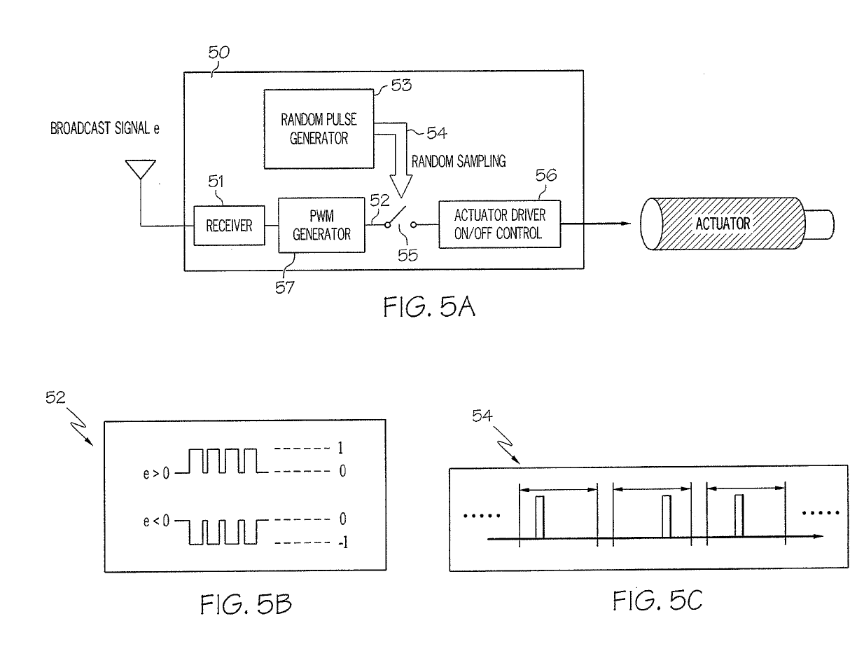

FIG. 5A contains a circuit diagram of the stochastic state machine embedded in each cellular unit, and FIG. 5B and FIG. 5C are timing diagrams for signals within the stochastic state machine, in accordance with one embodiment of the present invention.

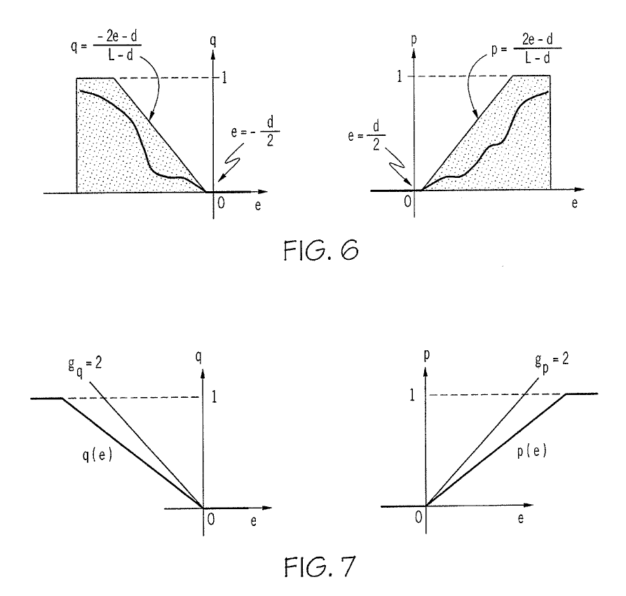

FIG. 6 illustrates transition probabilities for each cell that guarantee stochastic stability of the aggregate output of the system in accordance with one embodiment of the present invention.

FIG. 7 illustrates a method for modulating broadcasted error to transition probabilities in accordance with one embodiment of the present invention.

### DETAILED DESCRIPTION OF THE INVENTION

The present invention is concerned with the control of a system comprising vast numbers of subsystems, whose aggregate outputs are to follow commanded reference inputs. As the number of subsystems becomes larger, it is infeasible or inefficient for a central controller to directly control individual subsystems by delivering individual control commands to the individual subsystems. Such a centralized, direct control entails not only a large computing power, but also wiring and addressing of all the subsystems so that the individual commands can be delivered to the corresponding subsystems. This invention provides for eliminating individual wiring and addressing as well as reducing computational load for the central controller.

One possible solution is to apply a broadcast-control in which the centralized controller broadcasts the control signal without addressing many cells, and allows an individual unit to decide whether to accept or ignore the signal. The invention provides a broadcast feedback approach to the distributed stochastic control of an actuator system including many cellular units. The output of the actuator system is an aggregate effect of numerous cellular units, each taking a bistable ON-OFF state. A central controller broadcasts the error between the aggregate output and a reference input. Rather than dictating the individual units to take specific states, the central controller broadcasts the overall error signal to all the cellular units uniformly. In turn each cellular unit makes a stochastic decision with a state transition probability, which is modulated in relation to the broadcasted error. Even in the absence of deterministic coordination, the ensemble of the cellular units can track a given trajectory stably and robustly. Stability conditions of the broadcast feedback system are obtained by using a stochastic Lyapunov function.

In one embodiment, the invention is directed to an artificial cellular actuator, including many units of smart actuator material with a random signal generator.

In the invention, the central controller observes aggregate outputs coming out of the whole subsystems, compares them against the reference inputs, and informs the subsystems of the discrepancy between the two. Instead of determining each subsystem's control decision and sending the individual command to each subsystem, the central controller only informs the subsystems about the aggregate errors by broadcasting the error information across the subsystems. Since all of the subsystems receive the same broadcasted error information, no individual wiring and addressing are needed for delivering commands to them. In turn, each subsystem, receiving the same aggregate error signals, makes a control decision stochastically based on state transition probabilities that are modulated in response to the broadcasted error signals. When the aggregate error is zero, the transition probabilities are zero so that the whole system can stay at the given reference point. As the aggregate error becomes non-zero, the transition probabilities are varied in such a way that more subsystems are likely to make transitions towards the equilibrium, i.e., the point of zero aggregate error. Although the central controller does not command each subsystem to take a deterministic action, the whole system is pushed so that the aggregate error may be reduced. The control method of this invention guarantees that the aggregate output of vast numbers of subsystems can converge to reference inputs stably and robustly. Under mild conditions, it is shown that the ensemble behavior of the overall system is guaranteed to track desired reference inputs in a stochastic sense.

Referring now to the invention in more detail, FIG. 1A contains a perspective view of cellular actuators and FIG. 1B contains a detailed perspective view of a cellular actuator with a stochastic state machine in accordance with one embodiment of the present invention. In FIGS. 1A and 1B, there is shown an embodiment of the invention for a new cellular actuator structure. An actuator is considered in which small actuator units, called “cellular actuators,” are connected to each other directly or through mechanical impedance, in series, in parallel, or a mixture of both, composing in totality a single actuator. The aim of the control for this actuator is to modify the aggregate output of the cellular units, i.e., displacement between 1 and 2 depicted in FIG. 1A.

Instead of wiring many control lines to the individual cells, each cellular actuator 4 has a decision-making unit 5 that decides whether to accept or ignore the broadcasted control signal e 6 in a stochastic manner, as shown in view 3. This local control unit controls the cellular unit in an ON-OFF manner. The embodiment of this decision making unit will be described below.

The cellular architecture has an important feature with respect to speed of response. As the size of cellular units is reduced, the speed of response increases for those actuator materials that entail transport of matter. Activating SMA requires heat transfer, and conducting polymers requires ion doping. Common to all these actuator materials is that the speed of response increases when the actuator materials are segmented into many small units or thin films, and the reservoir of ions or heat is placed close to the cellular units. For example, thin film SMA has a small thermal capacitance, thus the response time is substantially reduced as presented by Fu et al (Y. Fu, H. Du, W. M. Huang, S. Zhang, and M. Hu, “TiNi-Based Thin Films in MEMS Applications: A Review,” Sensors and Actuators A Physical, Vol. 112, pp. 395-408, 2004.).

FIG. 2 contains a perspective view of a broadcast control approach in accordance with one embodiment of the present invention. FIG. 2 illustrates a broadcast control approach for cellular control systems. The centralized controller 21 performs control by observing the limited outputs of the system such as a reference input r and the output of the actuator y, which is equivalent to the displacement between 1 and 2 in FIG. 1A. The controller 21 broadcasts from 20 a signal that adequately compensates for the error. The simplest implementation of this control is a proportional controller that generates the error e between the reference and the current output.

The controller 21 does not coordinate the vast number of cellular actuators. The control signal is broadcasted to all cellular actuators uniformly and does not specify which actuator to be activated. As a result, this approach reduces the effort for complex wiring and contributes to simplify the structure.

FIG. 3 contains a stochastic state machine modulated by a broadcasted signal e in accordance with one embodiment of the present invention. As depicted in FIG. 3, each cellular unit makes a stochastic decision with a state transition probability, which is modulated in relation to the broadcasted error. More specifically, each cell has a decision-making unit that changes the transition probability from one state (e.g., OFF) to the other (e.g., ON) by receiving a broadcast signal. In one embodiment, p (0<=p<=1) is the transition probability from OFF to ON, and q (0<=q<=1) is the transition probability from ON to OFF. Each unit takes a binary state, which can be modeled as ON-OFF finite state machines.

Bi-stable ON-OFF control has salient features in coping with complex nonlinearities of actuator materials. Most materials for artificial muscle actuators have prominent hysteresis as shown in FIG. 4 and state-dependent complex nonlinearities. FIG. 4 illustrates a method for avoiding hysteresis of the material by a bistable ON-OFF control. For example, for shape memory alloys (SMAs), the input is temperature and the output is strain. For piezoelectric devices, the input is the voltage charged to the material. As also shown in FIG. 4, bi-stable ON-OFF control does not depend on these complex nonlinearities, as long as the state of the material is pushed towards either the ON or the OFF state. Dynamic transition may be influenced by the varying nonlinearities. Nonetheless, the control problem becomes much simpler for ON-OFF control.

FIG. 5A contains a circuit diagram of the stochastic decision-making unit, state machine, embedded in each cellular unit, and FIG. 5B and FIG. 5C are timing diagrams of signals within the stochastic state machine, in accordance with one embodiment of the present invention. A block 50 is equivalent to the stochastic decision-making unit shown in FIG. 3. The broadcasted signal e is received by a signal receiver, block 51. A pulse-width modulation signal PWM is generated by a PWM generator 57 based on this received signal e by which the duty cycle of the PWM signal is modulated in a certain method described later.

As illustrated in FIG. 5B, which illustrates signal 52 of FIG. 5A, if the broadcasted signal e is positive, the PWM generator 57 generates a nonnegative PWM signal that takes either 0 or 1. Similarly, as illustrated in FIG. 5B, which illustrates signal 52, if the broadcasted signal e is negative, the PWM generator 57 generates a non-positive PWM signal that takes either −1 or 0.

Each cell has a random pulse generator 53. The random pulse generator 53 randomly outputs a single pulse with in a specific time period, as illustrated in FIG. 5C, which illustrates signal 54 of FIG. 5A. The random pulse generator 53 can be implemented by various methods such as by a chaos signal generator or a random number generator.

A sampler 55 samples the PWM signal in sync with the random pulses. An actuator driver 56, performs a ON-OFF control for a small actuator unit. The behavior of the actuator driver 56 is shown in Table 1.

TABLE 1

| current | sampled | |
|---|---|---|
| state | signal | Transition |
| ON | 1(e > 0) | stay ON |
| | 0 | stay ON |
| | −1(e < 0) | turn OFF |
| OFF | 1(e > 0) | turn ON |
| | 0 | stay OFF |
| | −1(e < 0) | stay OFF |

Based on the current state and the sampled signal, it makes a transition from one state to another. Since the PWM signal is modulated by the broadcasted signal, the state transition is performed with a probability modulated by the broadcasted signal.

In more detail, referring to FIGS. 1A, 1B, 2 and 3, the transition probabilities p and q play a fundamental role in the tracking performance of the system. These transition probabilities can be designed as follows such that the output y converges to the reference r with probability of one (1). To simplify the analysis, it is assumed that all actuator units are uniform in size, i.e., providing a uniform displacement given by d. Also assume that each cell provides a uniform displacement regardless of the stress applied to the cell.

In one embodiment, N cells are connected just in series, such that the aggregate output is given by the summation of displacement of all cells. In an embodiment where N is the number of the cells, L=Nd represents the total displacement. The output is measured at discrete time t=0, 1, 2 . . . . The central controller calculates the aggregate output error, i.e., the difference between the reference input and the current aggregate output: et=r−yt, and broadcasts it to all the cells.

The stochastic Lyapunov function based on the aggregate error given as follows:

Vₜ^{s}=eₜ². Equation 1

The theory of martingale convergence, the stochastic stability condition for the convergence of the error is as follows

$$\begin{matrix}Δ {V}^{S} = E [ {V}_{t + 1}^{S} \vert {e}_{t} ] - {V}_{t}^{S} \\ = Var [ {e}_{t + 1} \vert {e}_{t} ] + {E [ {e}_{t + 1} \vert {e}_{t} ]}^{2} - {e}_{t}^{2} \\ = - k ( {e}_{t} ) \leq 0 ,\end{matrix} \qquad Equation 2$$

where the error et converges to {e:k(e)=0}. For example, the transition probabilities given by

$$\begin{matrix}p ( e ) = \{ \begin{matrix}0 & e \leq 0 \\ 0 < p < min ( 1 , \frac{2 e - d}{L - d} ) & e > 0\end{matrix} \\ and & Equation 3 \\ q ( e ) = \{ \begin{matrix}0 < q < min ( 1 , \frac{- 2 e - d}{L - d} ) & e < 0 \\ 0 & e \geq 0\end{matrix} & Equation 4\end{matrix}$$

guarantee the convergence of e to {e:|e|<d/2} with probability of one (1). These transition probabilities are also shown in FIG. 6. This convergence can be checked by calculating the expectation at time t+1 given by

E[eₜ₊₁|eₜ, r]=eₜ+p(r−L−eₜ)(eₜ>0)

E[eₜ₊₁|eₜ, r]=eₜ−q(r−eₜ)(eₜ>0) Equation 5

and substituting it into Equation 2. It is noted that the stability condition described above is sufficient and different stability analyses can be applied.

In further detail, still referring to the transition probabilities for FIG. 3, if the number of the actuator units, N, is large enough, the transition probabilities given by

$$\begin{matrix}p ( e ) = \{ \begin{matrix}0 & e \leq 0 \\ min ( 1 , {g}_{p} e / L ) & e > 0\end{matrix} \\ and & Equation 6 \\ q ( e ) = \{ \begin{matrix}min ( 1 , - {g}_{q} e / L ) & e < 0 \\ 0 & e \geq 0\end{matrix} & Equation 7\end{matrix}$$

that are proportional to the broadcasted error guarantee the stability. These transition probabilities are shown in FIG. 7. FIG. 7 illustrates a method for modulating broadcasted error to transition probabilities in accordance with one embodiment of the present invention. In Equation 6 and Equation 7, gₚ and g_{q} are the gains for which the stability is guaranteed if the condition given by

0<gₚ, g_{q}<2 Equation 8

is satisfied.

The advantages of the present invention include, without limitation, that complex wiring and addressing are not necessary to coordinate a large number of cellular units. This allows using very small actuator units for faster response without increasing the complexity of the system.

According to the invention, a very simple control such as a proportional control of the tracking error for the central controller can be applied. This implies that the central controller does not need to know the internal states of the system, such as the number of ON and OFF cells, or even the number of total cells. In general, stability and performance could be improved by observing internal states of the system. However, both the central controller and local controllers for individual cells would become more complex, which is not acceptable for a large-scale cellular control system.

In addition, if there are a large enough number of actuator units in the system, a transition probability proportional to the broadcasted signal guarantees the stability. A PWM signal generator with this feature can be easily implemented.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A control system comprising:
a plurality of small cellular units, wherein each of the plurality of cellular units comprises a stochastic state machine that controls the state of the unit modulated by a command broadcasted by a central controller.

2. The system in accordance with claim 1, wherein the plurality of cellular units are actuators.

3. The system in accordance with claim 2, wherein the plurality of cellular units are connected to each other directly.

4. The system in accordance with claim 1, wherein the stochastic state machine has two states and controls the cellular unit in a binary manner.

5. The system in accordance with claim 2, wherein the actuator is made by actuator material with hysteresis, and a bi-stable ON-OFF control is applied to avoid nonlinear transitions.

6. The system in accordance with claim 1, wherein the central controller broadcasts the signal based on a reference input and an aggregate output of the plurality of cellular units.

7. The system in accordance with claim 6, wherein the central controller broadcasts an error between the reference input and the aggregate output of the plurality of cellular units.

8. The system in accordance with claim 4, wherein the stochastic state machine is comprised of a pulse-width modulator (PWM) which modulates the broadcasted signal, a sampler which samples an output signal of the PWM in sync with a random pulse generator, and a bi-stable ON-OFF controller which controls the plurality of cellular units.

9. The system in accordance with claim 7, wherein a transition probability for each cell is proportional to the broadcasted error.

10. The system in accordance with claim 4, wherein the actuator is made by actuator material with hysteresis, and a bi-stable ON-OFF control is applied to avoid nonlinear transitions.

11. The system in accordance with claim 3, wherein the plurality of cellular units are connected to each other directly in series.

12. The system in accordance with claim 3, wherein the plurality of cellular units are connected to each other directly in parallel.

13. The system in accordance with claim 3, wherein the plurality of cellular units are connected to each directly in a combination of in series and in parallel.

14. The system in accordance with claim 2, wherein the plurality of cellular units are connected to each other through mechanical impedance.

15. The system in accordance with claim 14, wherein the plurality of cellular units are connected to each other through mechanical impedance in series.

16. The system in accordance with claim 14, wherein the plurality of cellular units are connected to each other through mechanical impedance in parallel.

17. The system in accordance with claim 14, wherein the plurality of cellular units are connected to each other through mechanical impedance in a combination of in series and in parallel.
